(19) United States
(12) Patent Application Publication
(10) Pub. No.: US 2023/0348270 A1
(43) Pub. Date: Nov. 2, 2023

(54) COMPOSITION FOR GENERATING OXYGEN, OXYGEN GENERATOR, AND METHOD OF GENERATING OXYGEN

(71) Applicant: Diehl Aviation Gilching GmbH, Gilching (DE)

(72) Inventors: Christoph Kallfass, Schwäbisch Hall (DE); Lars Fritze, Würzburg (DE); Maik Finze, Waldbrunn (DE)

(21) Appl. No.: 18/306,271

(22) Filed: Apr. 25, 2023

(30) Foreign Application Priority Data
Apr. 27, 2022 (DE) 10 2022 110 173.8

(51) Int. Cl. C01B 13/02

(52) U.S. Cl. CPC C01B 13/0207; C01B 13/0296

(57) ABSTRACT

A composition for generating oxygen includes, or is exclusively formed of, the following constituents: an oxygen source, the oxygen source being potassium superoxide, and a water-containing solution or a water-containing mixture. The water-containing solution contains such an amount of a salt or such an amount of a salt together with such an amount of an antifreeze or the water-containing mixture contains such an amount of an antifreeze, that the freezing point of the solution or of the mixture is lowered by at least 10° C. compared to the freezing point of the water. There is also described an oxygen generator and a method of generating oxygen.

### CROSS-REFERENCE TO RELATED APPLICATION

This application claims the priority, under 35 U.S.C. § 119, of German Patent Application DE 10 2022 110 173.8, filed Apr. 27, 2022; the prior application is herewith incorporated by reference in its entirety.

### FIELD AND BACKGROUND OF THE INVENTION

The present invention relates to a composition for generating oxygen, in particular breathable oxygen, to an oxygen generator, to a method for generating oxygen, in particular breathable oxygen, and to the use of the composition. The composition comprises an oxygen source.

Humans cannot survive without oxygen. However, in many environments the supply of oxygen is insufficient or there is the risk of emergency situations involving a lack of oxygen. In order to generate breathable oxygen, it is possible to use various types of chemical oxygen generators. One type of such a chemical oxygen generator uses peroxides as the oxygen source, for example sodium percarbonate, sodium perborate, or a urea adduct of hydrogen peroxide. The decomposition of the peroxides yields oxygen and the decomposition reaction can be started by bringing the peroxide compounds into contact with a suitable enzyme or transition metal catalyst. Chemical oxygen generators of this kind are disclosed in U.S. Pat. No. 2,035,896, WO 86/02063 A1, JP S61227903 A, and DE 196 02 149 A1.

European published patent application EP 3 323 782 A1 discloses ionic liquids that are used as solvent in an oxygen-generating composition. The composition comprises at least one oxygen source, at least one ionic liquid and at least one metal oxide compound, where the oxygen source comprises a peroxide compound and the ionic liquid is in the liquid state at least in a temperature range from −10° C. to +50° C. The metal oxide compound is an oxide of a single metal or of two or more different metals, the metal(s) being selected from the metals of groups 2 to 14 of the periodic table of the elements.

International patent application WO 2006/001607 A1 discloses oxygen-generating compositions comprising potassium superoxide or sodium peroxide, a material for stabilizing the reactivity and the oxidizing power of potassium superoxide or sodium peroxide and optionally at least one catalyst selected from an oxidation catalyst for carbon monoxide, a material for improving mouldability and processibility of the composition and a material for increasing the initial carbon dioxide absorption rate. The material for stabilizing the reactivity and the oxidizing power of potassium superoxide or sodium peroxide is selected from calcium hydroxide, aluminum hydroxide, magnesium hydroxide, barium hydroxide, calcium carbonate, talc and clay. The catalyst for the oxidation of carbon monoxide is selected from copper oxide, manganese oxide and a mixture thereof (hopcalite). The material for improving the mouldability and processibility of the oxygen-generating compositions is selected from glass powder, glass fibres, ceramic fibres, steel wool, bentonite, kaolinite, sodium silicate and potassium silicate.

U.S. Pat. No. 4,490,274 discloses a chemical composition comprising oxygenic ingredients and activators which, when activated, generate oxygen for use in breathing mixtures, the oxygenic ingredients being potassium superoxide and sodium peroxide and the activators being aluminum hydroxide, manganese dioxide and powdered aluminum. The ratio of the chemical composition corresponds to 10-20% by weight sodium peroxide, 15-25% by weight aluminum hydroxide, 5-7% by weight manganese oxide, 2.5-3.5% by weight aluminum powder. The remaining proportion of the chemical composition corresponds to potassium superoxide.

Published patent application US 2017/0263989 A1 discloses an electrochemical lithium-air cell. The battery comprises an anode space, a cathode space and a lithium ion-conducting membrane separating the anode space form the cathode space. The anode chamber comprises an anode comprising lithium, a lithium alloy or a porous material that can adsorb and release lithium, and a lithium ion electrolyte, while the cathode chamber comprises an air electrode, an ionic liquid that can facilitate the reduction of oxygen, and a dissolved concentration of potassium superoxide. The lithium ion concentration in the cathode space is low compared to the potassium ion concentration.

Published patent application US 2021/0147232 A1 discloses a composition for generating oxygen, comprising an oxygen source, an ionic liquid, a metal salt and a basic compound, wherein the oxygen source comprises a peroxide compound, the ionic liquid is in a liquid state in a temperature range from −10° C. to +50° C. and the metal salt comprises a single metal or two or more different metals and an organic and/or an inorganic anion. Mentioned as possible oxygen sources are alkali metal percarbonates, alkali metal perborates, urea hydrogen peroxide and mixtures thereof.

U.S. Pat. No. 4,963,327 discloses an apparatus and a method for selectively absorbing undesired organic and inorganic vapors and gases from ambient air while simultaneously increasing the oxygen content of the treated air. The absorption of carbon dioxide is here performed by a solid carbon dioxide absorber, which can be lithium hydroxide. Examples of oxygen-generating compounds mentioned are alkali metal and alkaline earth metal peroxides, superoxides, trioxides, percarbonates, permanganates and mixtures thereof. The reaction of these compounds with the moisture from the respiratory air is sufficient for oxygen release in the case of slow breathing. In the event of rapid breathing, the oxygen-generating compound is supplied with an aqueous solution of MgCl₂ comprising a small amount of surfactant from an attached reservoir. The MgCl₂ serves here as an antifreeze agent and as a decomposition agent for the alkaline salts from the oxygen-generating compound/water/carbon dioxide reaction. An insoluble gel of magnesium hydroxide/carbonate is formed together with pH-neutral salt. Instead of MgCl₂, it is possible to use other salts that bring about reductions in the freezing point in aqueous solutions, if they form essentially insoluble compounds in a reaction with alkali metal hydroxides and/or alkali metal carbonates. Examples include CaCl₂), FeCl₃ and ZnCl₂.

### SUMMARY OF THE INVENTION

It is accordingly an object of the invention to provide an oxygen generating composition which overcomes a variety of disadvantages of the heretofore-known devices and methods of this general type and which provides for an alternative composition for generating oxygen and an alternative oxygen generator. The intention is furthermore to specify a method and a use for generating oxygen.

With the above and other objects in view there is provided, in accordance with the invention, a composition for generating oxygen, the composition comprising:
an oxygen source, the oxygen source being potassium superoxide;
a water-containing solution or a water-containing mixture, the water-containing solution containing a given amount of a salt or a given amount of a salt together with a given amount of an antifreeze, or the water-containing mixture containing a given amount of an antifreeze, to effectively lower a freezing point of the water-containing solution or of the water-containing by at least 10° C. compared to a freezing point of the water;
the salt of the water-containing solution being an alkali metal hydroxide, an alkali metal hydroxide hydrate, an alkali metal chloride, an alkali metal chloride hydrate, a hydroxide with an organic cation, a hydrate of a hydroxide with an organic cation, or a mixture of at least two compounds selected from the group consisting of an alkali metal hydroxide, an alkali metal hydroxide hydrate, an alkali metal chloride, an alkali metal chloride hydrate, a hydroxide with an organic cation, and a hydrate of a hydroxide with an organic cation;
the antifreeze including an alcohol or consisting of an alcohol.

In other words, the invention relates to a composition for generating oxygen, wherein the composition comprises or consists of the following constituents: an oxygen source, the oxygen source being potassium superoxide, and a water-containing solution or a water-containing mixture, wherein the water-containing solution contains such an amount of a salt or such an amount of a salt together with such an amount of an antifreeze or the water-containing mixture contains such an amount of an antifreeze, that the freezing point of the solution or of the mixture is lowered by at least 10° C. compared to the freezing point of the water. The salt of the water-containing solution is an alkali metal hydroxide, an alkali metal hydroxide hydrate, an alkali metal chloride, an alkali metal chloride hydrate, a hydroxide with an organic cation, a hydrate of a hydroxide with an organic cation, or a mixture of at least two selected from an alkali metal hydroxide, an alkali metal hydroxide hydrate, an alkali metal chloride, an alkali metal chloride hydrate, a hydroxide with an organic cation and a hydrate of a hydroxide with an organic cation. The antifreeze comprises an alcohol or consists of an alcohol. The salt can be a salt that is present in the form of a solid.

The water-containing solution can in the simplest case consist only of water and the salt, or of water, the salt and the antifreeze. The water-containing mixture can in the simplest case consist only of water and the antifreeze.

For the generation of oxygen, the composition according to the invention does not require any peroxide compound as oxygen source or any metal oxide compound, in particular any metal oxide compound as catalyst or any oxidation catalyst for carbon monoxide. In one configuration, the composition according to the invention also does not comprise any of the compounds mentioned or any oxidation catalyst for carbon monoxide. The composition according to the invention differs greatly from the compositions for generating oxygen known from EP 3 323 782 A1, EP 3 323 470 A1, EP 3 604 212 B1, WO 2006/001607 A1 and U.S. Pat. No. 4,490,274.

In contrast with the non-aqueous composition known from US 2017/0263989 A1 in the electrochemical lithium-air cell, the composition according to the invention for generating oxygen comprises a water-containing solution or a water-containing mixture. If the composition in the lithium-air cell contained water, it would form oxygen and destroy the lithium-air cell.

In contrast with the method known from US 2021/0147232 A1, in the composition according to the invention and in the method according to the invention the presence of water in the water-containing solution or water-containing mixture is essential for the release of the oxygen. In the method known from US 2021/0147232 A1, in contrast, the presence of the metal salt is essential for the release of the oxygen.

In contrast with to the apparatus known from U.S. Pat. No. 4,963,327, the composition according to the invention does not contain any salt that forms essentially insoluble compounds on reaction with alkali metal hydroxides and/or alkali metal carbonates. In the composition according to the invention and the method according to the invention that is performed using said composition, the mass formation of insoluble reaction products would lead to reduced contact of the potassium superoxide with water and hence to a reduced generation of oxygen.

The method according to the invention ensures a generation of oxygen by way of the composition according to the invention which is scalable even at very low temperatures. At the same time, the composition according to the invention generates oxygen continuously and uniformly and in a relatively broad temperature range, in particular in a temperature range from −40° C. to +70° C. The continuous and uniform generation of oxygen can be ensured in this case over a comparatively long period of time.

The oxygen can be breathable oxygen, especially for use in emergencies. In this case, a composition from which oxygen can be generated only in traces or as a mixture with another, non-breathable, gas, such as carbon monoxide, ammonia, chlorine or a chlorine compound or two or more chlorine compounds, would not be a composition for generating breathable oxygen.

The oxygen source is potassium superoxide. The oxygen source is always a solid at room temperature and in a temperature range that is possibly encountered for an emergency oxygen generator. The inventors have found that the composition according to the invention releases oxygen immediately after bringing the oxygen source and the water-containing solution or the water-containing mixture into contact with one another. They have further found that oxygen is immediately released, even at a relatively low temperature, in particular at a temperature in a range from −40° C. to −20° C., and in an amount sufficient for supplying oxygen to a human at a scale suitable for an emergency system, for example in an aircraft.

The water-containing solution can contain such an amount of the salt or of the salt together with such an amount of the antifreeze or the water-containing mixture can contain such an amount of the antifreeze, that the freezing point of the solution or of the mixture is lowered by at least 15° C., in particular by at least 20° C., in particular by at least 25° C., in particular by at least 30° C., in particular by at least 35° C., in particular by at least 40° C., in particular by at least 45° C., in particular by at least 50° C., compared with the freezing point of the water. The water-containing solution or the water-containing mixture is a low-freezing solution or a low-freezing mixture, respectively. As a result of the fact that the freezing point is lowered to a relatively low temperature, oxygen generation is ensured at relatively low temperatures by virtue of the liquid state of the water-containing solution or of the water-containing mixture.

The water-containing solution is prepared by completely or partially dissolving the salt in water. The alkali metal hydroxide can be lithium hydroxide, sodium hydroxide, potassium hydroxide, rubidium hydroxide or cesium hydroxide. The alkali metal hydroxide can in particular be potassium hydroxide. The alkali metal hydroxide hydrate can be a hydrate of lithium hydroxide, a hydrate of sodium hydroxide, a hydrate of potassium hydroxide, a hydrate of rubidium hydroxide or a hydrate of cesium hydroxide. The alkali metal chloride can be lithium chloride, sodium chloride, potassium chloride, rubidium chloride or cesium chloride. The alkali metal chloride hydrate can be a hydrate of lithium chloride. The hydroxide with an organic cation can be a tetraalkylammonium hydroxide, in particular tetramethylammonium hydroxide, tetraethylammonium hydroxide, tetrapropylammonium hydroxide, tetrabutylammonium hydroxide, triethylmethylammonium hydroxide, tetrapentylammonium hydroxide or tetrahexylammonium hydroxide. The hydrate of a hydroxide with an organic cation can be a hydrate of a tetraalkylammonium hydroxide. The hydrate of the tetraalkylammonium hydroxide can be a hydrate of tetramethylammonium hydroxide, a hydrate of tetraethylammonium hydroxide, a hydrate of tetrapropylammonium hydroxide, a hydrate of tetrabutylammonium hydroxide, a hydrate of triethylmethylammonium hydroxide, a hydrate of tetrapentylammonium hydroxide or a hydrate of tetrahexylammonium hydroxide.

The tetraalkylammonium hydroxide or the hydrate of the tetraalkylammonium hydroxide can be present dissolved in water or in a monohydric alcohol, in particular methanol, ethanol, propanol or isopropanol. The total weight of the tetraalkylammonium hydroxide or of the hydrate of the tetraalkylammonium hydroxide in relation to the total weight of the solution or of the mixture can be at least 5% by weight and at most 80% by weight, in particular at least 10% by weight and at most 70% by weight, in particular at least 20% by weight and at most 60% by weight, in particular at least 30% by weight and at most 50% by weight.

The antifreeze can comprise a monohydric alcohol, in particular ethanol or octanol, a dihydric alcohol, in particular propylene glycol or ethylene glycol, a trihydric alcohol, in particular glycerol, or a mixture of at least two selected from a monohydric alcohol, in particular ethanol or octanol, a dihydric alcohol, in particular propylene glycol or ethylene glycol, and a trihydric alcohol, in particular glycerol. Alternatively, the antifreeze can consist of a monohydric alcohol, in particular ethanol or octanol, a dihydric alcohol, in particular propylene glycol or ethylene glycol, a trihydric alcohol, in particular glycerol, or a mixture of at least two selected from a monohydric alcohol, in particular ethanol or octanol, a dihydric alcohol, in particular propylene glycol or ethylene glycol, and a trihydric alcohol, in particular glycerol.

The total weight of the salt or the total weight of the salt together with the total weight of the antifreeze in the water-containing solution in relation to the total weight of the water-containing solution or the total weight of the antifreeze in the water-containing mixture in relation to the total weight of the water-containing mixture can be at least 5% by weight, in particular at least 10% by weight, in particular at least 15% by weight, in particular at least 20% by weight, in particular at least 25% by weight, in particular at least 28% by weight, in particular at least 30% by weight, in particular at least 35% by weight, in particular at least 40% by weight, in particular at least 45% by weight, in particular at least 50% by weight. The maximum total weight of the salt in relation to the total weight of the water-containing solution is reached when the water-containing solution is saturated with the salt. The water-containing solution can be a saturated aqueous solution of the salt. A saturated aqueous solution of the salt in the water-containing solution is understood to be an aqueous solution of the salt in which, for a given temperature, the maximum possible amount of the salt is present in dissolved form. In the water-containing solution, the salt can also be present in such an amount that the salt in the water-containing solution is present partly in undissolved form, in particular in the form of a suspension.

The inventors have found that a relatively high total weight of the salt or of the salt together with the total weight of the antifreeze in the water-containing solution or of the antifreeze in the water-containing mixture in relation to the total weight of the water-containing solution or mixture, with the resulting relatively low freezing point of the solution or mixture, enables sufficient oxygen generation even at a temperature much less than 0° C. Oxygen generation is made possible as a result of the liquid state of the solution or mixture at relatively low temperatures. The salt and/or the antifreeze can be present in the solution or mixture at such a concentration that the water-containing solution or mixture is liquid at a temperature in a temperature range from −80° C. to 0° C., in particular at a temperature in a temperature range from −60° C. to 0° C., in particular at a temperature in a temperature range from −50° C. to −10° C., in particular at a temperature in a temperature range from −40° C. to −20° C., in particular at a temperature in a temperature range from −35° C. to −25° C. This ensures the generation of oxygen by the composition according to the invention even at relatively low temperatures, especially at a temperature within the temperature ranges mentioned.

The salt in the water-containing solution can in particular be potassium hydroxide. The inventors have found that, with a total weight of the potassium hydroxide of 25% by weight in relation to the total weight of the water-containing solution, the freezing point of the water-containing solution is −40° C. The inventors have also found that, with a total weight of the potassium hydroxide of 28% by weight in relation to the total weight of the water-containing solution, the freezing point of the water-containing solution is −50° C. They have further found that the composition generates oxygen for as long as the water-containing solution or mixture is liquid, i.e., even at a temperature which is only so slightly above the freezing point that the water-containing solution or mixture is still liquid.

The oxygen source can be present, in particular as pure substance, in solid form. In particular, it can be present as a pure substance in solid form at 25° C.

The oxygen source can be present in an ionic liquid, in particular in an anhydrous ionic liquid, in suspended form, in particular in the form of a paste. The oxygen source and an ionic liquid, in particular an anhydrous ionic liquid, can be present in a pressed form with the (in particular anhydrous) ionic liquid as binder. The oxygen source and the ionic liquid can be present as a result as a solid-form shaped body formed by pressing.

The ionic liquid is a further salt consisting of at least one cation and at most 100 cations, in particular at most 80 cations, in particular at most 60 cations, in particular at most 40 cations, in particular at most 20 cations, in particular at most ten cations, in particular at most nine cations, in particular at most eight cations, in particular at most seven cations, in particular at most six cations, in particular at most five cations, in particular at most four cations, in particular at most three cations, in particular at most two cations, and at least one anion and at most 100 anions, in particular at most 80 anions, in particular at most 60 anions, in particular at most 40 anions, in particular at most 20 anions, in particular at most ten anions, in particular at most nine anions, in particular at most eight anions, in particular at most seven anions, in particular at most six anions, in particular at most five anions, in particular at most four anions, in particular at most three anions, in particular at most two anions. In particular, the ionic liquid can be a salt consisting of one or two cations and one or two anions. In one configuration, the ionic liquid has just one cation and/or just one anion. The ionic liquid has a melting point of less than 100° C. It may be an ionic liquid that is liquid at 85° C., in particular at 50° C., in particular at 0° C., in particular at −50° C. Here and hereinafter, the term “cation” is understood to mean a multiplicity of cations of the same type and the term “anion” is understood to mean a multiplicity of anions of the same type. For example, the feature “further salt consisting of at least one cation and at most ten cations and at least one anion and at most ten anions” means that the further salt consists of a multiplicity of cations of at least one type and at most ten types and of a multiplicity of anions of at least one type and at most ten types.

The ionic liquid is not a solution of a salt in a solvent, such as water, but instead a further salt that has a melting point of less than 100° C. It may be a further salt that is in the liquid state even at a temperature of much less than 100° C. The cation or one of the cations can be an ammonium ion, a substituted ammonium ion, in particular a tetraalkylammonium ion, a phosphonium ion, a substituted phosphonium ion, in particular a tetraalkylphosphonium ion, an N-monosubstituted or an N-disubstituted pyrrolidinium ion, an N-monosubstituted or an N′,N-disubstituted imidazolium ion or an N-monosubstituted pyridinium ion. The anion or one of the anions can be a halide ion, a tetrafluoroborate ion, a hexafluorophosphate ion, a cyanoborate ion, a substituted cyanoborate ion, in particular a perfluoroalkylcyanoborate ion, a sulfonate ion, in particular a perfluoroalkylsulfonate ion, a bisperfluoroalkylimide ion, a borate ion, a substituted borate ion, in particular a perfluoroalkylborate ion, a phosphate ion, a substituted phosphate ion, in particular a perfluoroalkylphosphate ion, or a perfluoroalkylfluorophosphate ion. The name element “perfluoroalkyl” denotes in general an aliphatic substance in which all hydrogen atoms bonded to carbon atoms of the unfluorinated substance derived therefrom are replaced by fluorine atoms, except for the hydrogen atoms the substitution of which would change the nature of the functional groups present.

A substituent of the N-monosubstituted pyrrolidinium ion, of the N-monosubstituted imidazolium ion and of the N-monosubstituted pyridinium ion, and at least one substituent of the N′,N-disubstituted imidazolium ion, and at least one substituent of the N-disubstituted pyrrolidinium ion, can be independently selected from alkyl, in particular methyl, ethyl, propyl or butyl, benzyl and aryl.

The bis(perfluoroalkyl)imide ion can be an ion having the general formula [N(SO₂R^{F}ₓ)₂]⁻, where x indicates the number of carbon atoms in the perfluoroalkyl substituent R^{F}. Preferably, x=1.

The perfluoroalkyl substituent R^{F} here has the general formula —CₓF₂ₓ₊₁. If x=1, the perfluoroalkyl substituent is perfluoromethyl having the molecular formula —CF₃. If x=2, the perfluoroalkyl substituent is perfluoroethyl having the molecular formula —C₂F₅. If x=3, the perfluoroalkyl substituent is perfluoropropyl having the molecular formula —C₃F₇.

The (perfluoroalkyl)(fluoro)(cyano)borate ion can be an ion having the general formula [R^{F}ₓBF_{y}(CN)_{z}]⁻, where x=0-4, where y=0-3, where z=0-4, where x+y+z=4. If x=0, it is a fluorocyanoborate ion. If y=0, it is a perfluoroalkylcyanoborate ion. If z=0, it is a perfluoroalkylfluoroborate ion. If x=0 and y=0, it is a tetracyanoborate ion. If x=0 and z=0, it is a tetrafluoroborate ion. If y=0 and z=0, it is a tetrakis(perfluoroalkyl)borate ion.

The perfluoroalkyl(fluoro)phosphate ion can be an ion having the general formula [R^{F}ₓPF₆₋ₓ]⁻, where x=1-3. If x=0, it is a hexafluorophosphate ion.

The inventors have found that an ionic liquid, especially an ionic liquid that contains an N-disubstituted pyrrolidinium ion having at least one alkyl substituent, especially methyl or butyl, or having two different alkyl substituents, especially methyl and butyl, is advantageous. The inventors have further found that an ionic liquid, especially an ionic liquid that contains a relatively hydrophobic anion, in particular a cyanoborate ion, a perfluoroalkylcyanoborate ion, a perfluoroalkylsulfonate ion, a bisperfluoroalkylimide ion, a perfluoro-alkylborate ion, a perfluoroalkylphosphate ion, or a perfluoroalkylfluorophosphate ion, is advantageous. A cation having at least one alkyl substituent and/or a relatively hydrophobic anion ensures a relatively high hydrophobicity of the ionic liquid. A relatively high hydrophobicity of the ionic liquid ensures a relatively low hygroscopicity of the ionic liquid. The inventors have further found that a relatively low hygroscopicity of the ionic liquid in the composition according to the invention ensures a relatively high stability of the relatively hydrolysis-sensitive potassium superoxide. The inventors have furthermore found that an ionic liquid, especially an ionic liquid that contains a halide ion, a tetrafluoroborate ion, a hexafluorophosphate ion, a perfluoroalkylcyanoborate ion, in particular a perfluoroalkylsulfonate ion, a bisperfluoroalkylimide ion, a perfluoroalkylborate ion, a perfluoroalkylphosphate ion or a perfluoroalkylfluorophosphate ion additionally ensures a relatively high electrochemical stability of the ionic liquid. The inventors assume that the relatively high electrochemical stability is in particular ensured by electronegative substituents, especially fluorine substituents, perfluoroalkyl substituents and cyano substituents. A relatively high electrochemical stability of the ionic liquid prevents the ionic liquid from entering into a reaction with a reactive ion species, in particular superoxide ions, in the composition according to the invention.

The inventors have also found that an ionic liquid, especially an ionic liquid that contains an N-disubstituted pyrrolidinium ion and/or a relatively hydrophobic anion, in particular a cyanoborate ion, a perfluoroalkylcyanoborate ion, a perfluoroalkylsulfonate ion, a bisperfluoroalkylimide ion, a perfluoro-alkylborate ion, a perfluoroalkylphosphate ion, or a perfluoroalkylfluorophosphate ion, ensures a relatively uniform generation of oxygen by the oxygen source over a relatively long period of time.

The ionic liquid can be an ionic liquid that is in the liquid state in a temperature range from −60° C. to +150° C., in particular in a temperature range from −55° C. to +140° C., in particular in a temperature range from −50° C. to +130° C., in particular in a temperature range from −45° C. to +120° C., in particular in a temperature range from −40° C. to +110° C., in particular in a temperature range from −35° C. to +100° C., in particular in a temperature range from −30° C. to +90° C., in particular in a temperature range from −25° C. to +80° C., in particular in a temperature range from −20° C. to +70° C.

Examples of suitable ionic liquids are [BMPL]Cl, [BMPL][CF₃SO₃], [BMPL][C₂F₅SO₃], [BMPL][C₄F₉SO₃], [BMPL][N(SO₂CF₃)₂], [BMPL][BF₄], [BMPL][BF₂(CN)₂], [BMPL][BF(CN)₃], [BMPL][B(CN)₄], [BMPL][CF₃BF₃], [BMPL][C₂F₅BF₃], [BMPL][CF₃BF₂(CN)], [BMPL][C₂F₅BF₂(CN)], [BMPL][CF₃BF(CN)₂], [BMPL][C₂F₅BF(CN)₂], [BMPL][CF₃B(CN)₃], [BMPL][C₂F₅B(CN)₃], [BMPL][PF₆], [BMPL][C₂F₅PF₅], [BMPL][(C₂F₅)₂PF₄], [BMPL][(C₂F₅)₃PF₃], [HMIm]Cl, [HMIm][CF₃SO₃], [HMIm][C₂F₅SO₃], [HMIm][C₄F₉SO₃], [HMIm][N(SO₂CF₃)₂], [HMIm][BF₄], [HMIm][BF₂(CN)₂], [HMIm][BF(CN)₃], [HMIm][B(CN)₄], [HMIm][CF₃BF₃], [HMIm][C₂F₅BF₃], [HMIm][CF₃BF₂(CN)], [HMIm][C₂F₅BF₂(CN)], [HMIm][CF₃BF(CN)₂], [HMIm][C₂F₅BF(CN)₂], [HMIm][CF₃B(CN)₃], [HMIm][C₂F₅B(CN)₃], [HMIm][PF₆], [HMIm][C₂F₅PF₅], [HMIm][(C₂F₅)₂PF₄], [HMIm][(C₂F₅)₃PF₃], [BMIm]Cl, [BMIm][CF₃SO₃], [BMIm][C₂F₅SO₃], [BMIm][C₄F₉SO₃], [BMIm][N(SO₂CF₃)₂], [BMIm][BF₄], [BMIm][BF₂(CN)₂], [BMIm][BF(CN)₃], [BMIm][B(CN)₄], [BMIm][CF₃BF₃], [BMIm][C₂F₅BF₃], [BMIm][CF₃BF₂(CN1)], [BMIm][C₂F₅BF₂(CN1)], [BMIm][CF₃BF(CN)₂], [BMIm][C₂F₅BF(CN)₂], [BMIm][CF₃B(CN)₃], [BMIm][C₂F₅B(CN)₃], [BMIm][PF₆], [BMIm][C₂F₅PF₅], [BMIm][(C₂F₅)₂PF₄], [BMIm][(C₂F₅)₃PF₃], [EMIm][CF₃SO₃], [EMIm][C₂F₅SO₃], [EMIm][C₄F₉SO₃], [EMIm][N(SO₂CF₃)₂], [EMIm][BF₄], [EMIm][BF₂(CN)₂], [EMIm][BF(CN)₃], [EMIm][B(CN)₄], [EMIm][CF₃BF₃], [EMIm][C₂F₅BF₃], [EMIm][CF₃BF₂(CN)], [EMIm][C₂F₅BF₂(CN)], [EMIm][CF₃BF(CN)₂], [EMIm][C₂F₅BF(CN)₂], [EMIm][CF₃B(CN)₃], [EMIm][C₂F₅B(CN)₃], [EMIm][PF₆], [EMIm][C₂F₅PF₅], [EMIm][(C₂F₅)₂PF₄] and [EMIm][(C₂F₅)₃PF₃]. Further examples of suitable ionic liquids are [MMIm][SO4Me], [EMIm][SO4Et], [BMIm][SO4Me], [BMIm][SO4Bu], [MMIm][PO4Me2], [EMIm][PO4Et2], [EEIm][PO4Et2], [BMIm][PO4Me2], [BMIm][PO4Bu2], [EMIm][H2PO4], [EMIm][HSO4], [BMIm][FeCl4], and [BMIm][BF4], [BMIm][PF6], [HMIm][BF4], [HMIm][PF6].

The following nomenclature applies: The first square brackets contain the cation and the second square brackets define the anion. The following established abbreviations also apply: BMPL: 1-butyl-1-methylpyrrolidinium, BMIm: 1-butyl-3-methylimidazolium, HMIm: 1-hexyl-3-methylimidazolium, EMIm: 1-ethyl-3-methylimidazolium, SO4Me: methylsulfate, SO4Et: ethylsulfate, SO4Bu: butylsulfate, PO4Me2: dimethylphosphate, PO4Et2: diethylphosphate, PO4Bu2: dibutylphosphate, HSO4: hydrogensulfate, H2PO4: dihydrogen-phosphate, FeCl4: tetrachloroferrate, BF4: tetrafluoroborate and PF6: hexafluorophosphate.

Three different ionic liquids with structural formulae are shown below for illustration purposes.

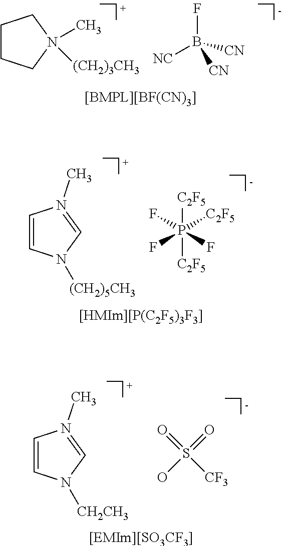

The ionic liquid is considered to be anhydrous not only when it contains no water, but also when it contains traces of water, in particular a water content of not more than 1% by weight, in particular of not more than 0.5% by weight, in particular of not more than 0.1% by weight, in particular of not more than 0.05% by weight, in particular of not more than 0.01% by weight, in particular of not more than 0.005% by weight, in particular of not more than 0.001% by weight. The inventors have found that in the composition according to the invention no chemical reaction takes place between the oxygen source and the anhydrous ionic liquid, or at the most a chemical reaction takes place until the water present in traces has been consumed. In addition, as a result of the oxygen source being present in the ionic liquid in suspended form, in particular in the form of a paste, or as a result of the oxygen source and the ionic liquid being present in pressed form with the ionic liquid as binder, it is ensured that the oxygen source is protected relatively well against undesired contact with water, in particular with atmospheric humidity. The protective effect of the ionic liquid, in particular an anhydrous ionic liquid, is stronger the more hydrophobic the ionic liquid is. On contact of the oxygen source with water, in particular with atmospheric humidity, the water reacts with the oxygen source hydrolytically. The hydrolytic reaction of the oxygen source leads to an undesired release of oxygen as a result of decomposition of the oxygen source. The protective effect of the ionic liquid ensures a relatively high stability of the oxygen source with respect to atmospheric humidity. The inventors have moreover found that the presence of an oxygen source in suspended form in the ionic liquid, in particular in the form of a paste, or the presence of the oxygen source and the ionic liquid in pressed form with the ionic liquid as binder, can ensure a relatively uniform generation of oxygen over a relatively long period of time, in particular over a period of time of at least 2 hours, in particular over a period of time of at least 2.5 hours, in particular over a period of time of at least 3 hours, in particular over a period of time of at least 3.5 hours.

In one embodiment of the invention, the composition comprises, as further constituent, at least one additive. The additive can be independently selected from sodium dihydrogenphosphate or potassium hydroxide present in solid form, an additional substance and an antifoam. The additional substance can be a phyllosilicate, in particular mica, or fumed silica. The antifoam can comprise or consist of octanol, paraffin wax or a polysiloxane. The oxygen source and the additive can be present together in pressed form. The oxygen source and the additive can be present together in a solid-form shaped body formed by pressing. The additive can be an additive serving either for accelerating or for slowing the generation of oxygen. By way of example, an acidic additive such as for example sodium dihydrogenphosphate present as a solid has the effect of accelerating oxygen generation and a basic additive such as for example potassium hydroxide present as a solid has the effect of slowing oxygen generation. Fumed silica can additionally be used to suppress floating of the oxygen source during the reaction for generating oxygen in the water-containing solution or in the water-containing mixture. This works particularly well when the oxygen source and the fumed silica are present together in a shaped body formed by pressing. As a result of suppressing floating of the oxygen source, a relatively uniform decomposition of the oxygen source is ensured during the reaction for generating oxygen in the water-containing solution or in the water-containing mixture. The antifoam can suppress foam formation during the generation of the oxygen and/or destroy foam that has formed during the generation of the oxygen. At least one additive can be present in the composition in a form that brings about a delayed release of the additive. For example, the additive may to this end be encapsulated in a capsule that slowly dissolves when it comes into contact with the water-containing solution or the water-containing mixture.

The total weight of the oxygen source in relation to the total weight of the composition according to the invention can be at least 5% by weight and at most 90% by weight, in particular at least 20% by weight and at most 80% by weight. The remaining part of the composition consists of the water-containing solution or the water-containing mixture and optionally the ionic liquid and/or the further constituent.

The oxygen source, the salt or the salt and the antifreeze of the water-containing solution, the antifreeze of the water-containing mixture, the water-containing solution and/or the water-containing mixture of the composition according to the invention can be present in a kit. The kit can also comprise each further constituent, especially the ionic liquid and/or the additive, that is optionally comprised by the composition according to the invention.

With the above and other objects in view there is also provided, in accordance with the invention, an oxygen generator, in particular for generating breathable oxygen, in particular for use in emergencies such as for example in an emergency rescue system. The oxygen generator comprises a first and a second compartment, an opening for releasing or a conduit for discharging oxygen formed in the oxygen generator and all constituents of the composition according to the invention. The oxygen source is present in the first compartment and the water-containing solution or the water-containing mixture is present in the second compartment. The oxygen generator comprises a physical barrier that separates the first compartment from the second compartment and a means for overcoming the physical barrier, wherein the physical barrier is arranged such that the oxygen source and the water-containing solution or the water-containing mixture after overcoming the physical barrier come into contact with one another. The opening or conduit is arranged such that oxygen forming as a result exits through the opening or through the conduit.

The physical barrier can be a valve that can be opened by the means. The physical barrier can also be a membrane or a film/foil, where the means for overcoming the physical barrier is a means for removing, destroying or piercing the membrane or film/foil, in particular a blade or a sharp object. The film/foil can be a plastics film or a metal foil.

The constituents, present in the oxygen generator, of the composition according to the invention can comprise, besides the oxygen source and the water-containing solution or the water-containing mixture, optionally each of the abovementioned further constituents of the composition according to the invention, in particular the ionic liquid and/or the additive. The ionic liquid can be present in the first compartment. The additive can be present either in the first compartment or in the second compartment.

The oxygen generator can additionally comprise at least one delaying device or means. The delaying device can be arranged and in particular configured such that a total amount of the water-containing solution present in the oxygen generator or a total amount of the water-containing mixture present in the oxygen generator, after overcoming the physical barrier, comes into contact only gradually with a total amount of the oxygen source present in the oxygen generator. The delaying device can be a semipermeable, i.e., gas-permeable and liquid-impermeable, membrane that surrounds the oxygen source and has at least one hole that limits the supply of liquid, or a bulk material, in particular sand or glass beads, which surrounds or covers the oxygen source or is mixed with the oxygen source and is inert with respect to the oxygen source and either the water-containing solution or the water-containing mixture. Limiting the supply of liquid has the result of delaying the oxygen source surrounded by the membrane from coming into contact with the solution or mixture, but does not restrict the exit of oxygen as a result of the semipermeability of the membrane. The inventors have found that the delaying means prevents a relatively rapid decomposition of the oxygen source in particular as a result of the entire oxygen source rapidly coming into contact with the entire water-containing solution or with the entire water-containing mixture. In addition, floating and/or foaming of the oxygen source during the reaction for generating oxygen in the water-containing solution or the water-containing mixture is prevented. This promotes a relatively uniform release of oxygen over a relatively long period of time.

With the above and other objects in view there is also provided, in accordance with the invention, a method for generating oxygen, in particular breathable oxygen, in particular for use in emergencies such as for example in an emergency rescue system. The method comprises providing the oxygen source and the water-containing solution or the water-containing mixture of the composition according to the invention and optionally the ionic liquid and/or the additive of the composition according to the invention and bringing these into contact with one another.

The oxygen source and the water-containing solution or the water-containing mixture can be provided and/or brought into contact with one another at a temperature in a range from −70° C. to +110° C., in particular in a range from −60° C. to +90° C., in particular in a range from −50° C. to +80° C., in particular in a range from −40° C. to +70° C., in particular in a range from −40° C. to 0° C., in particular in a range from −40° C. to −20° C. The inventors have found that, by bringing the oxygen source and the water-containing solution or the water-containing mixture into contact with one another even at a relatively low temperature, in particular at a temperature in a range from −40° C. to −20° C., oxygen is immediately generated by the composition according to the invention.

The inventors have also found that the method according to the invention ensures scalable generation of oxygen. The inventors have additionally found that the method according to the invention ensures a continuous and uniform generation of oxygen within a relatively broad temperature range, in particular in a temperature range from −40° C. to +70° C. The inventors have additionally found that the method according to the invention ensures the generation of oxygen without respiratory poisons, in particular without carbon monoxide, without ammonia, without chlorine and without a chlorine compound.

The invention further relates to a use of the oxygen source and the water-containing solution or the water-containing mixture of the composition according to the invention and optionally of the ionic liquid and/or the additive of the composition according to the invention for the generation of oxygen, in particular breathable oxygen, in particular for use in emergencies such as in an emergency rescue system. The use according to the invention can be a use in a hermetically sealed environment, such as for example in a submarine or a space capsule, or in an emergency situation, such as for example in the event of a sudden loss of pressure in an aircraft.

All of the features specified in the description are to be understood to be features that are applicable to all of the embodiments of the invention. This means for example that a feature specified for the composition can also be applied to the oxygen generator, the method according to the invention and/or the use according to the invention, and vice versa.

Further features which are considered as characteristic for the invention are set forth in the appended claims.

Although the invention is illustrated and described herein as embodied in a composition for generating oxygen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a graphical representation of the volume of oxygen released during the reactions for releasing oxygen as a function of the ambient temperature and of the reaction time;

FIG. 2 shows a graphical representation of the oxygen flow rates as a function of the ambient temperature and of the reaction time during reactions for releasing oxygen;

FIG. 3 shows a graphical representation of the volume of oxygen released during the reactions for releasing oxygen as a function of the water-containing solution and of the reaction time;

FIG. 4 shows a graphical representation of the volume of oxygen released by sodium peroxide as oxygen source during the reaction for releasing oxygen, as a function of the reaction time;

FIG. 5 shows a further graphical representation of the volume of oxygen released during the reactions for releasing oxygen as a function of the water-containing solution and of the reaction time;

FIG. 6 shows a graphical representation of the oxygen flow rates as a function of the water-containing solution and of the reaction time during reactions for releasing oxygen;

FIG. 7 shows a graphical representation of the volume of oxygen released during the reactions for releasing oxygen as a function of the reactor diameter and of the reaction time;

FIG. 8 shows a graphical representation of the oxygen flow rates as a function of the reactor diameter and of the reaction time during reactions for releasing oxygen;

FIG. 9 shows a graphical representation of the volume of oxygen released during the reactions for releasing oxygen as a function of the reactor base area and of the reaction time;

FIG. 10 shows a graphical representation of the oxygen flow rates as a function of the reactor base area and of the reaction time during reactions for releasing oxygen;

FIG. 11 shows a graphical representation of the linear relationship between reactor base area and oxygen flow rates during reactions for releasing oxygen;

FIG. 12 shows a graphical representation of the volume of oxygen released during the reactions for releasing oxygen as a function of the addition rate for the water-containing solution and of the reaction time;

FIG. 13 shows a graphical representation of the oxygen flow rates as a function of the addition rate for the water-containing solution and of the reaction time during reactions for releasing oxygen;

FIG. 14 shows a graphical representation of the volume of oxygen released during the reactions for releasing oxygen as a function of the height and nature of a bed and of the reaction time;

FIG. 15 shows a graphical representation of the oxygen flow rates as a function of the height and nature of a bed and of the reaction time during reactions for releasing oxygen;

FIG. 16 shows a graphical representation of the volume of oxygen released during the reactions for releasing oxygen as a function of the form of the oxygen source and of the reaction time;

FIG. 17 shows a graphical representation of the oxygen flow rates as a function of the form of the oxygen source and of the reaction time during reactions for releasing oxygen;

FIG. 18 shows a further graphical representation of the volume of oxygen released during the reactions for releasing oxygen as a function of the form of the oxygen source and of the reaction time;

FIG. 19 shows a further graphical representation of the oxygen flow rates as a function of the form of the oxygen source and of the reaction time during reactions for releasing oxygen;

FIG. 20 shows a graphical representation of the volume of oxygen released during the reactions for releasing oxygen with and without ionic liquid, as a function of the reaction time;

FIG. 21 shows a graphical representation of the oxygen flow rates as a function of the reaction time during reactions for releasing oxygen with and without ionic liquid;

FIG. 22 shows a graphical representation of the volume of oxygen released during the reaction for releasing oxygen as a function of the reaction time;

FIG. 23 shows a graphical representation of the oxygen flow rate as a function of the reaction time during the reaction for releasing oxygen;

FIG. 24 shows a graphical representation of the volume of oxygen released during the reactions for releasing oxygen as a function of the ionic liquid and of the reaction time;

FIG. 25 shows a graphical representation of the oxygen flow rates as a function of the ionic liquid and of the reaction time during reactions for releasing oxygen;

FIG. 26 shows a further graphical representation of the volume of oxygen released during the reactions for releasing oxygen as a function of the ambient temperature and of the reaction time; and

FIG. 27 shows a further graphical representation of the oxygen flow rates as a function of the ambient temperature and of the reaction time during reactions for releasing oxygen.

The acronym “IL” used in the figures and in the text below stands for “ionic liquid.”

### DETAILED DESCRIPTION OF THE INVENTION

### First Exemplary Embodiment

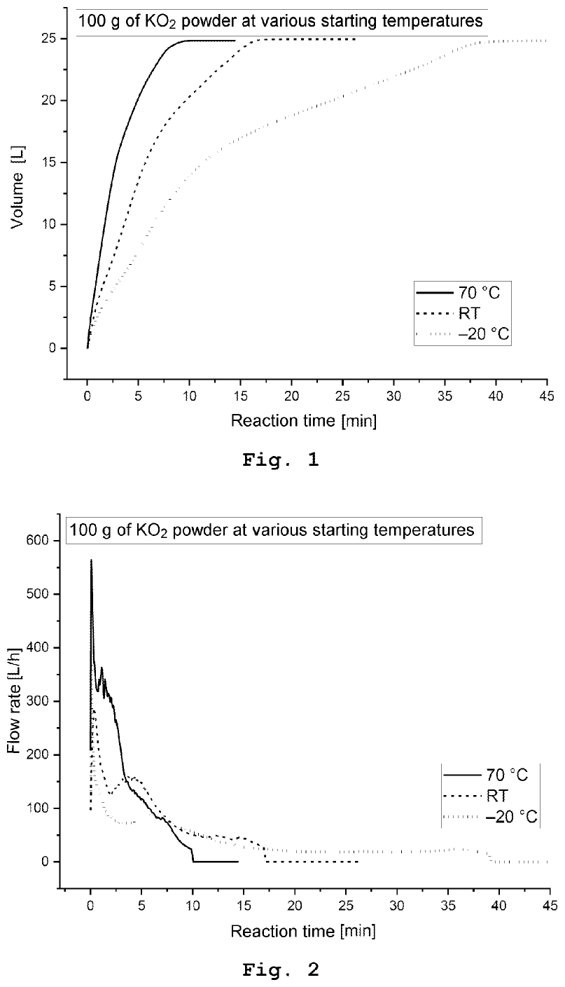

100 g in each case of pulverulent potassium superoxide was added as oxygen source to three cylindrical reaction vessels having an internal diameter of 55 mm. At an ambient temperature of +70° C., room temperature or −20° C., the reaction for generating oxygen was initiated by adding 100 mL in each case of an aqueous 9 M potassium hydroxide solution that had been adjusted to the respective ambient temperature. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. The results are presented in FIGS. 1 and 2 and in Table 1.

TABLE 1

| Starting | Flow | Reaction | O₂ | O₂ | Reaction |
|---|---|---|---|---|---|
| temperature | rateₘₐₓ | temperature | volume | volume | duration |
| [° C.] | [L/h] | [° C.] | [L] | [%] | [min] |
| −20 | 371 | 45 | 24.9 | 99 | 39 |
| RT | 287 | 64 | 24.9 | 99 | 17 |
| +70 | 564 | 85 | 24.9 | 99 | 10 |

It is apparent from this that, at an ambient temperature of +70° C., the maximum yield in gas volume of 24.9 L is reached after 10 minutes of reaction time. At an ambient temperature of room temperature, the maximum yield in gas volume of 24.9 L is reached after 17 minutes of reaction time. At an ambient temperature of −20° C., the maximum yield in gas volume of 24.9 L is reached after 39 minutes of reaction time. The flow curve profile ascertained via the measured flow rates has a markedly more plateau-shaped course at an ambient temperature of −20° C. As a result of an ambient temperature of −20° C., the oxygen is released more continuously and uniformly.

### Second Exemplary Embodiment

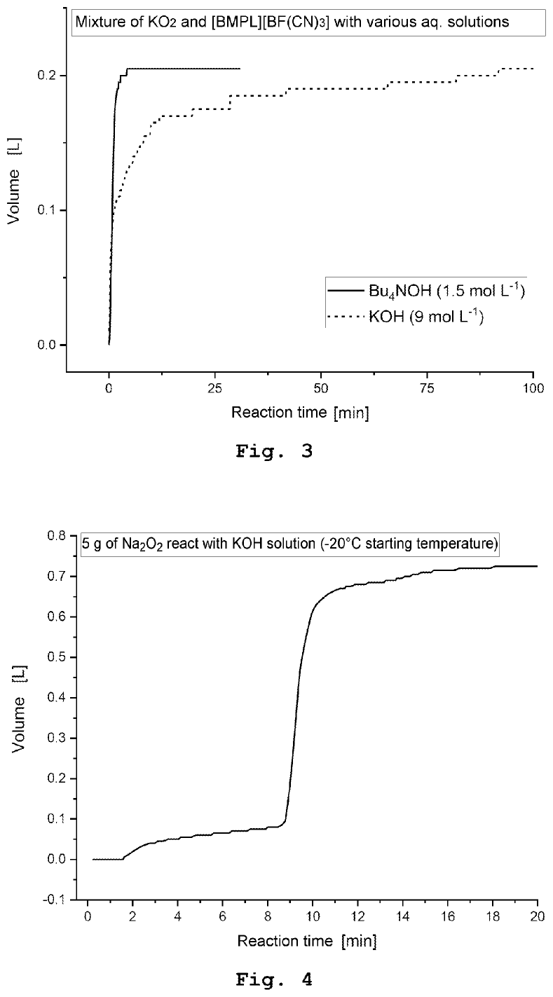

1 g in each case of pulverulent potassium superoxide was initially charged as oxygen source into two cylindrical reaction vessels having an internal diameter of 24 mm. 0.5 g of [BMPL][BF(CN)₃] were added in each case. Next, at an ambient temperature of room temperature, the reaction for generating oxygen was initiated by adding either 2 mL of an aqueous 9 M potassium hydroxide solution or 2 mL of an aqueous 1.5 M tetrabutylammonium hydroxide solution. The reaction vessels were each sealed and the oxygen released by the reaction for generating oxygen was guided out of the reaction vessels through a drum-type gas meter to measure the volume of the oxygen generated. The length of the reaction time was additionally measured. The results are presented in FIG. 3. It is apparent from this that, with the addition of an aqueous tetrabutylammonium hydroxide solution, the maximum yield in gas volume of 0.21 L is reached after 4 minutes of reaction time. The addition of an aqueous potassium hydroxide solution results in the maximum yield in gas volume of 0.21 L being reached after 92 minutes of reaction time. As a result of the addition of the aqueous potassium hydroxide solution, the oxygen is released over a longer period of time.

### Third Exemplary Embodiment

5 g of pulverulent sodium peroxide was initially charged as oxygen source into a cylindrical reaction vessel. Next, at an ambient temperature of −20° C., 5 mL of an aqueous 6.9 M potassium hydroxide solution comprising 2 mol % of the metal-containing catalyst manganese acetate (abbreviation: Mn(OAc)₂), were added, this being adjusted to an ambient temperature of −20° C. The reaction vessel was sealed and the oxygen released by the reaction for generating oxygen was guided out of the reaction vessel through a drum-type gas meter to measure the volume of the oxygen generated. The length of the reaction time was additionally measured. The reaction was terminated after 20 minutes. The result is presented in FIG. 4. It is apparent from this that, with sodium peroxide as oxygen source and at an ambient temperature of −20° C., an increase in the gas volume, measurable via the heating of the composition, is achieved after 8 minutes. However, the reaction for generating oxygen was initiated only after 2 minutes. A maximum yield in gas volume of 725 mL is reached after 18 minutes. In contrast to the results presented in FIGS. 1 and 2 and Table 1, the reaction for generating oxygen proceeds markedly more slowly with sodium peroxide as oxygen source than with potassium superoxide as oxygen source. Moreover, the addition of the metal-containing catalyst Mn(OAc)₂ is necessary when generating oxygen with sodium peroxide.

### Fourth Exemplary Embodiment

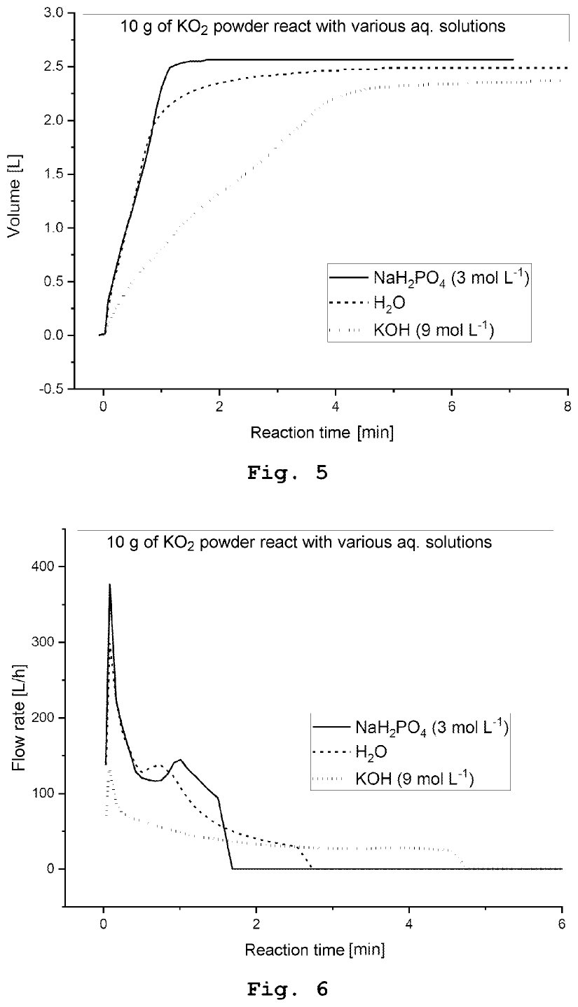

10 g in each case of pulverulent potassium superoxide was initially charged as oxygen source into three cylindrical reaction vessels having an internal diameter of 28 mm. Next, at an ambient temperature of room temperature, the reaction for generating oxygen was initiated by adding either 20 mL of water, 20 mL of an aqueous 9 M potassium hydroxide solution or 20 mL of an aqueous 3 M sodium dihydrogenphosphate solution. The pH of the water was 7. The pH of the aqueous 9 M potassium hydroxide solution was 15. The pH of the aqueous 3 M sodium dihydrogenphosphate solution was 3. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurements was halted after 8 minutes since in all cases an oxygen yield of 99% had been achieved. The results are presented in FIGS. 5 and 6 and in Table 2.

TABLE 2

| Aqueous solution | Reaction | Flow | O₂ | O₂ |
|---|---|---|---|---|
| (Concentration | temperature | rateₘₐₓ | volume | volume |
| [mol L⁻¹]) | [° C.] | [L/h] | [L] | [%] |
| KOH (9) | 49 | 135 | 2.5 | 99 |
| H₂O | 63 | 299 | 2.5 | 99 |
| NaH₂PO₄ (3) | 81 | 377 | 2.5 | 99 |

It is apparent from this that, for all reactions, a maximum yield in gas volume of 2.5 L is reached. Addition of water resulted in the achievement of a maximum reaction temperature of 63° C. and a maximum oxygen flow rate of 299 L/h. Addition of the aqueous potassium hydroxide solution resulted in the achievement of a maximum reaction temperature of 49° C. and a maximum oxygen flow rate of 135 L/h. Addition of aqueous sodium dihydrogenphosphate solution resulted in the achievement of a maximum reaction temperature of 81° C. and a maximum oxygen flow rate of 377 L/h. Depending on whether and in which concentration a salt has been dissolved in the aqueous solution, this has an influence on the maximum reaction temperature and on the maximum oxygen flow rate during the reaction for generating oxygen. Here, a higher maximum reaction temperature results in a higher maximum oxygen flow rate. The flow curve profile ascertained via the measured flow rates has a markedly more plateau-shaped course as a result of the addition of the aqueous potassium hydroxide solution. As a result of the addition of the aqueous potassium hydroxide solution, the oxygen is released more continuously and more uniformly.

### Fifth Exemplary Embodiment

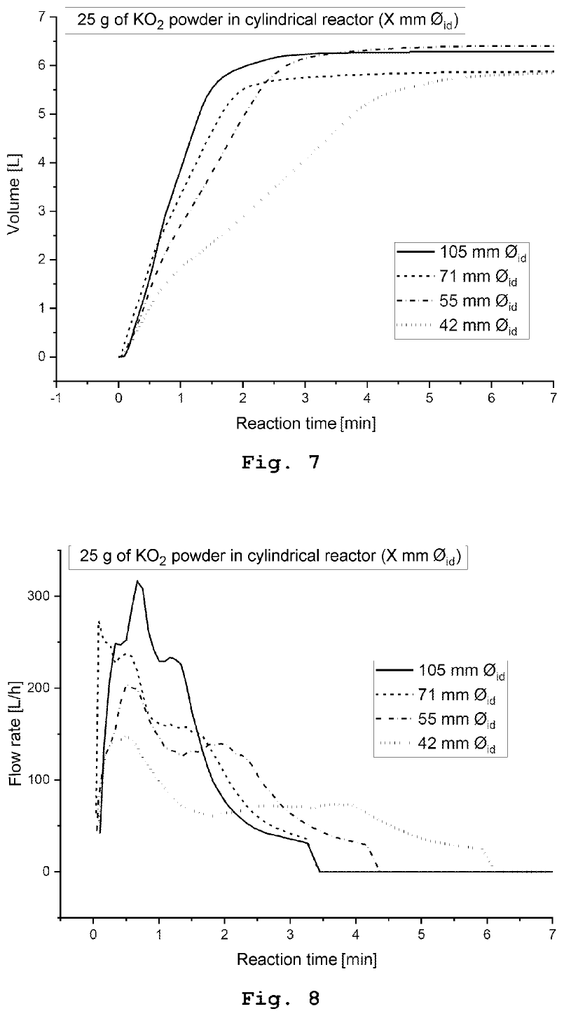

25 g in each case of pulverulent potassium superoxide was initially charged as oxygen source into four cylindrical reaction vessels having an internal diameter of either 42 mm, 55 mm, 71 mm or 105 mm. Next, at an ambient temperature of room temperature, the reaction for generating oxygen was initiated by adding 50 mL in each case of an aqueous 9 M potassium hydroxide solution. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurement data was halted after 7 minutes since in all cases a yield of 98% of the achievable oxygen volume had been reached. The results are presented in FIGS. 7 and 8 and in Table 3.

TABLE 3

| Internal | Flow | O₂ | O₂ |
|---|---|---|---|
| diameter | rateₘₐₓ | volume | volume |
| [mm] | [L/h] | [L] | [%] |
| 42 | 148 | 6.4 | 98 |
| 55 | 203 | 6.4 | 98 |
| 71 | 273 | 6.4 | 98 |
| 105 | 316 | 6.4 | 98 |

It is apparent from this that, for all reactions, a maximum yield in gas volume of 6.4 L is reached. With an internal diameter of the cylindrical reaction vessel of 42 mm, a maximum oxygen flow rate of 148 L/h is reached. With an internal diameter of the cylindrical reaction vessel of 55 mm, a maximum oxygen flow rate of 203 L/h is reached. With an internal diameter of the cylindrical reaction vessel of 71 mm, a maximum oxygen flow rate of 273 L/h is reached. With an internal diameter of the cylindrical reaction vessel of 105 mm, a maximum oxygen flow rate of 316 L/h is reached. The internal diameter of the cylindrical reaction vessel has an influence on the maximum oxygen flow rate during the reaction for generating oxygen. In this case, a greater internal diameter of the cylindrical reaction vessel results in a higher maximum oxygen flow rate. The flow curve profile ascertained via the measured flow rates has a markedly more plateau-shaped course in the case of an internal diameter of the cylindrical reaction vessel of 42 mm. With an internal diameter of the cylindrical reaction vessel of 42 mm, the oxygen is released more continuously and more uniformly.

### Sixth Exemplary Embodiment

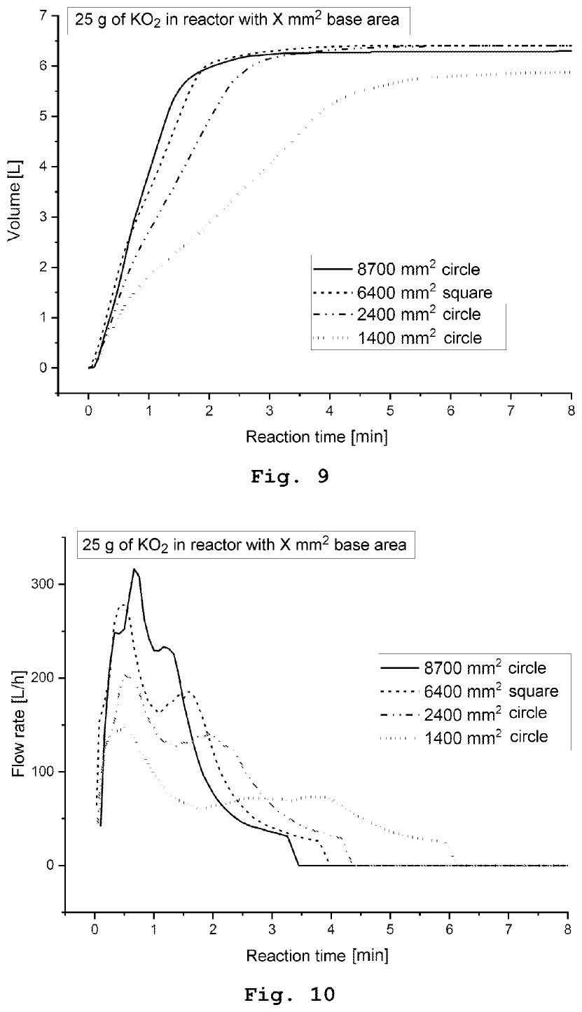

25 g in each case of pulverulent potassium superoxide was initially charged into four reaction vessels. The reaction vessels had either a circular base area shape with an internal diameter of 42 mm (1400 mm² base area), 71 mm (2400 mm² base area) or 105 mm (8700 mm² base area) or or a square base area shape with an internal diameter of 80 mm (6400 mm² base area). Next, at an ambient temperature of room temperature, the reaction for generating oxygen was initiated by adding 50 mL in each case of an aqueous 9 M potassium hydroxide solution. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurement data was halted after 8 minutes since in all cases a yield of 98% of the achievable oxygen volume had been reached. The results are presented in FIGS. 9 and 10 and in Table 4.

TABLE 4

| Base area | Flow | O₂ | O₂ |
|---|---|---|---|
| [mm²] | rateₘₐₓ | volume | volume |
| (shape) | [L/h] | [L] | [%] |
| 1400 (circle) | 148 | 6.4 | 98 |
| 2400 (circle) | 203 | 6.4 | 98 |
| 6400 (square) | 277 | 6.4 | 98 |
| 8700 (circle) | 316 | 6.4 | 98 |

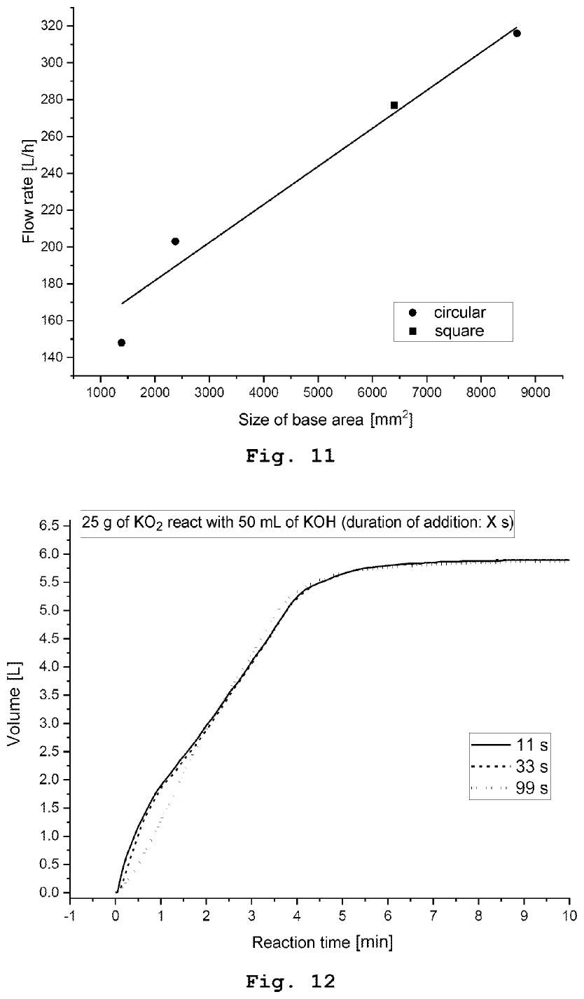

It is apparent from this that, for all reactions, a maximum yield in gas volume of 6.4 L is reached. With a circular base area of 1400 mm², a maximum oxygen flow rate of 148 L/h is reached. With a circular base area of 2400 mm², a maximum oxygen flow rate of 203 L/h is reached. With a square base area of 6400 mm², a maximum oxygen flow rate of 277 L/h is reached. With a circular base area of 8700 mm², a maximum oxygen flow rate of 316 L/h is reached. The base area of the reaction vessel has an influence on the maximum oxygen flow rate during the reaction for generating oxygen. A linear relationship between base area of the reaction vessel and maximum oxygen flow rate is presented in FIG. 11. It is apparent from this that a greater base area of the reaction vessel results in a higher maximum oxygen flow rate. It is moreover apparent from this that the base area shape of the reaction vessel does not have any influence on the maximum oxygen flow rate. The flow curve profile ascertained via the measured flow rates has a markedly more plateau-shaped course in the case of a base area of the reaction vessel of 1400 mm². With a base area of the reaction vessel of 1400 mm², the oxygen is released more continuously and more uniformly.

### Seventh Exemplary Embodiment

25 g in each case of pulverulent potassium superoxide was added as oxygen source to three cylindrical reaction vessels having an internal diameter of 42 mm. At an ambient temperature of room temperature, the reaction for generating oxygen was initiated by adding 50 mL in each case of aqueous 9 M potassium hydroxide solution. The 50 mL of the aqueous potassium hydroxide solution was added within an addition time of either 11 seconds, 33 seconds or 99 seconds. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. The reactions were terminated after 10 minutes. The results are presented in FIGS. 12 and 13. It is apparent from this that, for all reactions, a maximum yield in gas volume of 5.9 L is reached. The flow curve profile ascertained via the measured flow rates has a markedly more plateau-shaped course with an addition time of 99 seconds. The addition time for the aqueous potassium hydroxide solution has an influence on the maximum oxygen flow rate during the reaction for generating oxygen. In this case, a longer addition time for the aqueous potassium hydroxide solution results in a lower maximum oxygen flow rate.

### Eighth Exemplary Embodiment

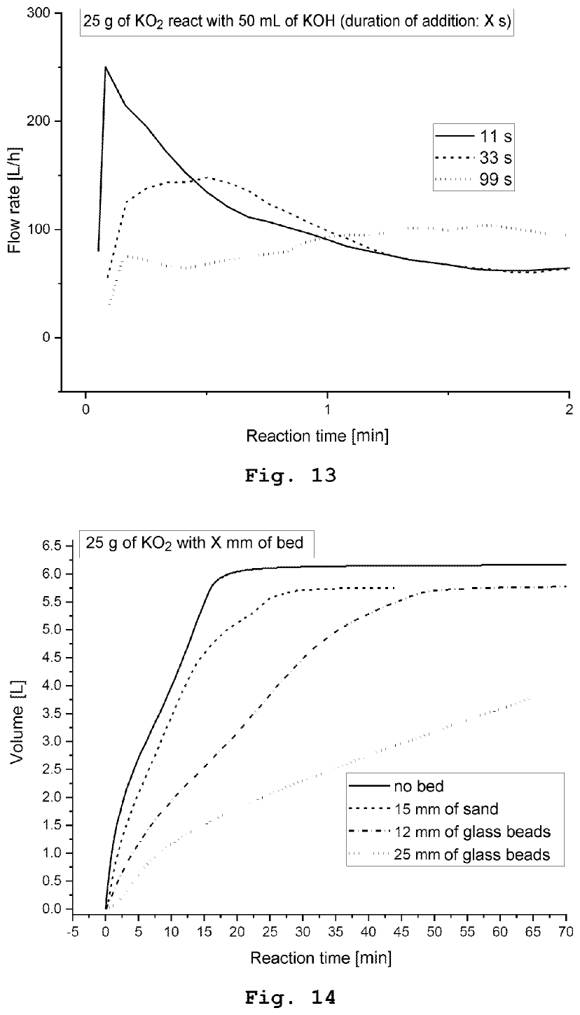

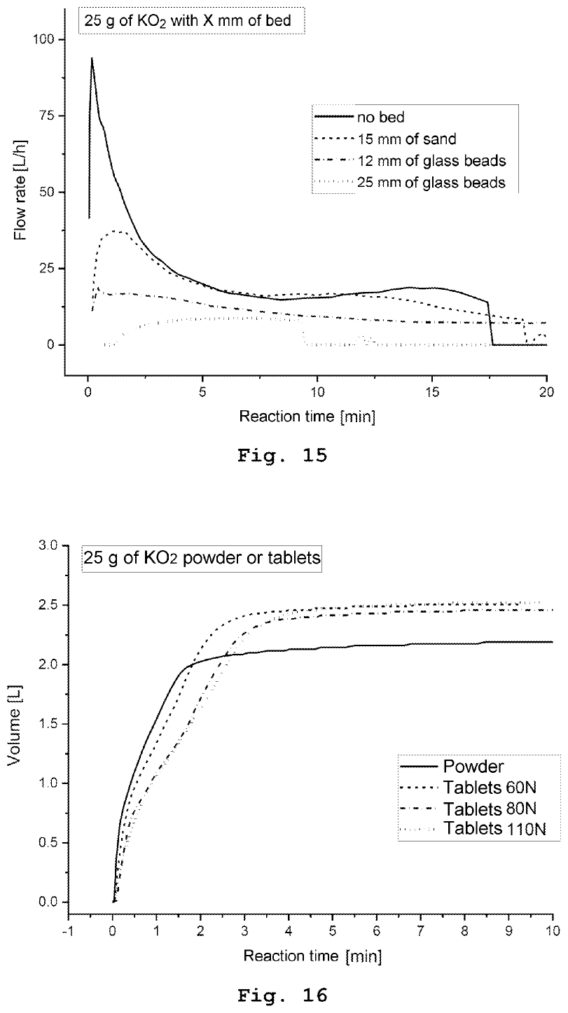

25 g in each case of pulverulent potassium superoxide was initially charged as oxygen source into four cylindrical reaction vessels having an internal diameter of 42 mm. In the reaction vessels, the initially charged potassium superoxide was overlaid either with a bed of sea sand with a bed height of 15 mm or with a bed of glass beads with a bed height of either 12 mm or 25 mm. In one reaction vessel, the initially charged potassium superoxide was not overlaid with a bed. Next, at an ambient temperature of −20° C., 50 mL in each case of an aqueous 9 M potassium hydroxide solution, adjusted to an ambient temperature of −20° C., were added to the reaction vessels. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. The reactions were terminated after 70 minutes. The results are presented in FIGS. 14 and 15 and in Table 5.

TABLE 5

| | | After 15 min | |
|---|---|---|---|
| | | of reaction time | |
| | Flow | O₂ | O₂ |
| Nature of bed | rateₘₐₓ | volume | volume |
| (height [mm]) | [L/h] | [L] | [%] |
| Without | 94 | 5.49 | 84 |
| Sea sand (15) | 37 | 4.58 | 70 |
| Glass beads (12) | 18 | 2.54 | 39 |
| Glass beads (25) | 8.5 | 1.50 | 23 |

It is apparent from this that, after 15 minutes of reaction time, a maximum yield in gas volume of 5.49 L and a maximum oxygen flow rate of 94 L/h is made possible with the reaction without bed. For the reaction with a bed of sea sand having a bed height of 15 mm, a maximum yield in gas volume of 4.58 L and a maximum oxygen flow rate of 37 L/h is made possible after 15 minutes of reaction time. For the reaction with a bed of glass beads having a bed height of 12 mm, a maximum yield in gas volume of 2.54 L and a maximum oxygen flow rate of 18 L/h is made possible after 15 minutes of reaction time. For the reaction with a bed of glass beads having a bed height of 25 mm, a maximum yield in gas volume of 1.50 L and a maximum oxygen flow rate of 8.5 L/h is made possible after 15 minutes of reaction time. The nature and height of the bed has an influence on the maximum oxygen flow rate during the reaction for generating oxygen. In this case, a greater bed height results in a lower oxygen flow rate during the reaction for generating oxygen. The flow curve profile ascertained via the measured flow rates has a markedly more plateau-shaped course for the reactions with potassium superoxide overlaid with a bed. In the reactions with potassium superoxide overlaid with a bed, oxygen is released more continuously and more uniformly. This is down to the fact that the bed enables fixing of the potassium superoxide in the reaction vessel. Floating and/or swirling of the potassium superoxide as a result of the addition of the aqueous potassium hydroxide solution is thus prevented. Foaming during the reaction for generating oxygen is also prevented by the bed.

### Ninth Exemplary Embodiment

10 g in each case of potassium superoxide were initially charged, as powder or pressed in the form of tablets having a fracture resistance of either 60 N, 80 N or 110 N, into four cylindrical reaction vessels having an internal diameter of 28 mm.

Here and hereinafter, the fracture resistance denotes the mechanical strength of a pressed tablet with respect to a diametrically acting force at the time of fracture (European Pharmacopoeia. 8th ed. 2014; 2.9.8). The fracture resistance of the tablet is determined as the radial fracture resistance or compressive strength of the tablet by crushing the tablet between two jaws.

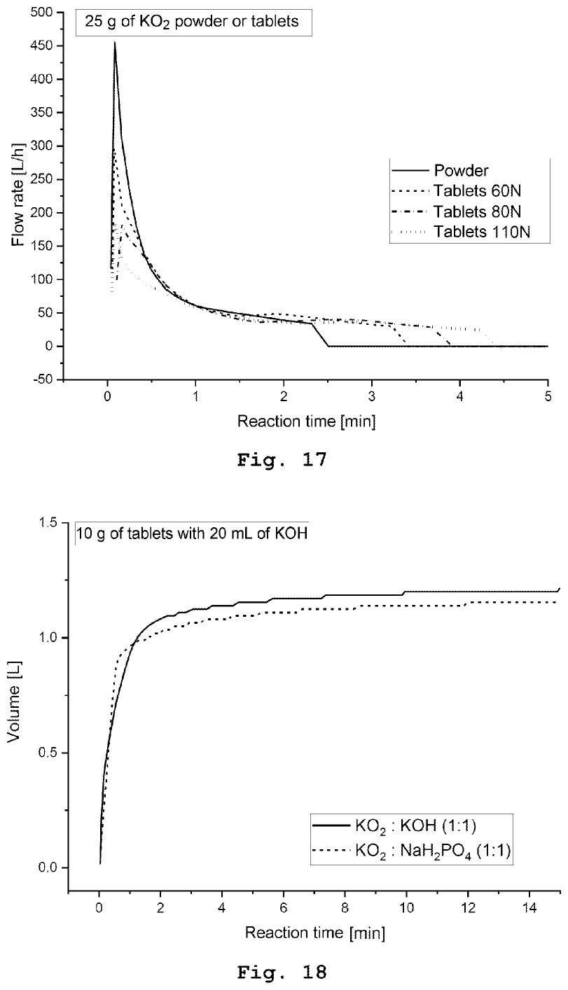

Next, at an ambient temperature of room temperature, the reaction for generating oxygen was initiated by adding 20 mL in each case of a 9 M potassium hydroxide solution. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. The potassium superoxide powder was stirred during the addition of the aqueous 9 M potassium hydroxide solution and during the whole reaction time in order to avoid sticking of the surface as a result of reaction products. The reactions were terminated after 10 minutes. The results are presented in FIGS. 16 and 17 and in Table 6.

TABLE 6

| | Flow | Reaction | O₂ | O₂ |
|---|---|---|---|---|
| Source (fracture | rateₘₐₓ | temperature | volume | volume |
| resistance) | [L/h] | [° C.] | [L] | [%] |
| Powder | 456 | 46 | 2.2 | 85 |
| Tablets (60N) | 297 | 48 | 2.5 | 96 |
| Tablets (80N) | 182 | 48 | 2.5 | 96 |
| Tablets (110N) | 189 | 48 | 2.5 | 96 |

It is apparent from this that, for the reaction with pulverulent potassium superoxide, a maximum yield in gas volume of 2.2 L is reached. For the reactions of potassium superoxide in tablet form, a maximum yield in gas volume of 2.5 L is reached. With pulverulent potassium superoxide, a maximum oxygen flow rate of 456 L/h is reached. With potassium superoxide pressed into tablets, a maximum oxygen flow rate of 297 L/h is reached with a fracture resistance of 60 N, a maximum oxygen flow rate of 182 L/h is reached with a fracture resistance of 80 N and a maximum oxygen flow rate of 189 L/h is reached with a fracture resistance of 110 N. The fracture resistance of the tablet has an influence on the maximum oxygen flow rate during the reaction for generating oxygen. In this case, a higher fracture resistance of the tablet results in a lower maximum oxygen flow rate.

### Tenth Exemplary Embodiment

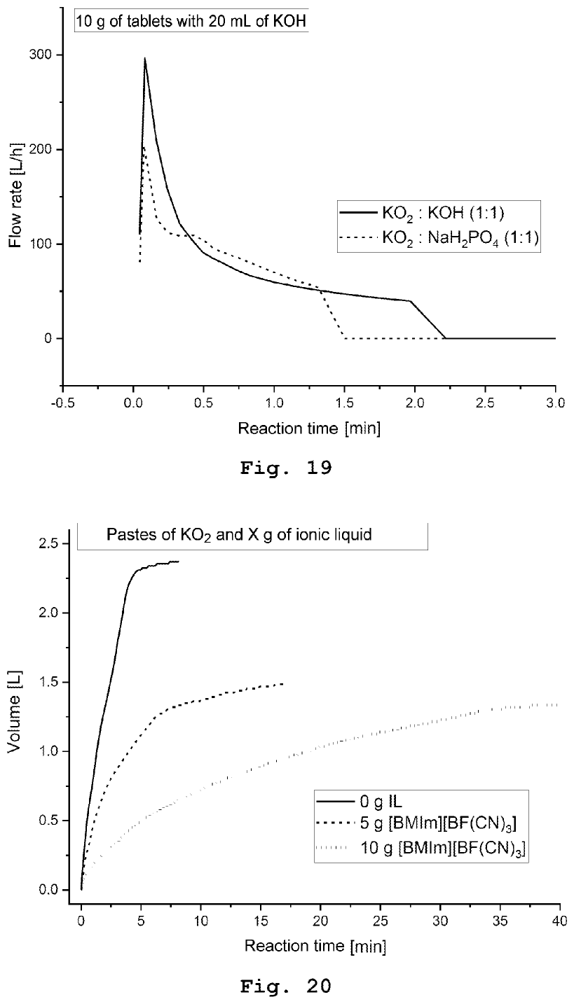

5 g in each case of potassium superoxide were pressed, either with 5 g of potassium hydroxide or with 5 g of sodium dihydrogenphosphate, into tablets having a fracture resistance of 60 N (mass ratio 1:1 in each case). 10 g of these tablets were initially charged in each case into two cylindrical reaction vessels having an internal diameter of 28 mm. Next, at an ambient temperature of room temperature, the reaction for generating oxygen was initiated by adding 20 mL in each case of a 9 M potassium hydroxide solution. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. The reactions were terminated after 15 minutes. The results are presented in FIGS. 18 and 19 and in Table 7.

TABLE 7

| | Flow | Reaction | O₂ | O₂ |
|---|---|---|---|---|
| Tablet contents | rateₘₐₓ | temperature | volume | volume |
| (mass ratio) | [L/h] | [° C.] | [L] | [%] |
| KO₂, KOH (1:1) | 297 | 44 | 1.2 | 96 |
| KO₂, NaH₂PO₄ | 205 | 55 | 1.2 | 96 |
| (1:1) | | | | |

It is apparent from this that, for both reactions, a maximum yield in gas volume of 1.2 L is reached. For tablets consisting of potassium superoxide and potassium hydroxide in a mass ratio of 1:1, a maximum oxygen flow rate of 297 L/h and a maximum reaction temperature of 44° C. are reached. For tablets consisting of potassium superoxide and sodium dihydrogenphosphate in a mass ratio of 1:1, a maximum oxygen flow rate of 297 L/h and a maximum reaction temperature of 55° C. are reached.

### Eleventh Exemplary Embodiment

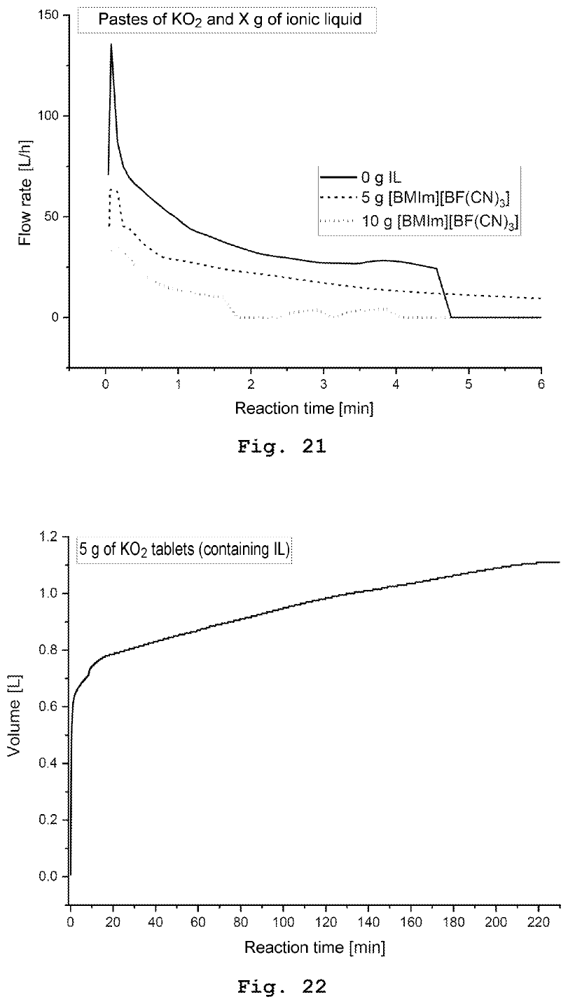

10 g of pulverulent potassium superoxide were initially charged as oxygen source in a cylindrical reaction vessel having an internal diameter of 28 mm. A further cylindrical reaction vessel having an internal diameter of 28 mm was initially charged with 15 g of a paste consisting of 10 g of potassium superoxide as oxygen source and 5 g of [BMIm][BF(CN)₃]. A further cylindrical reaction vessel having an internal diameter of 28 mm was initially charged with 20 g of a paste consisting of 10 g of potassium superoxide as oxygen source and 10 g of [BMIm][BF(CN)₃]. Next, at an ambient temperature of room temperature, the reaction for generating oxygen was initiated by adding 20 mL in each case of a 9 M potassium hydroxide solution. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. The reactions were terminated after 40 minutes. The results are presented in FIGS. 20 and 21 and in Table 8.

TABLE 8

| | | After 10 minutes of reaction time | | |
|---|---|---|---|---|
| | Flow | Reaction | O₂ | O₂ |
| | rateₘₐₓ | temperature | volume | volume |
| IL | [L/h] | [° C.] | [L] | [%] |
| Without | 135 | 49 | 2.37 | 95 |
| 5 g of IL | 63 | 29 | 1.47 | 58 |
| 10 g of IL | 36 | 26 | 0.90 | 35 |

It is apparent from this that, with pulverulent potassium superoxide, the maximum yield in gas volume of 2.37 L is reached after 8 minutes of reaction time. The maximum gas volume that can theoretically be generated in this reaction is 2.51 L. The flow curve profile ascertained via the measured flow rates has a markedly more plateau-shaped course in the case of the pastes consisting of potassium superoxide and [BMIm][BF(CN)₃]. In the case of the pastes consisting of potassium superoxide and [BMIm][BF(CN)₃], the oxygen is released more continuously and more uniformly. The oxygen is released more continuously and more uniformly the greater the total weight of the ionic liquid is in relation to the total weight of the potassium superoxide in the paste.

### Twelfth Exemplary Embodiment

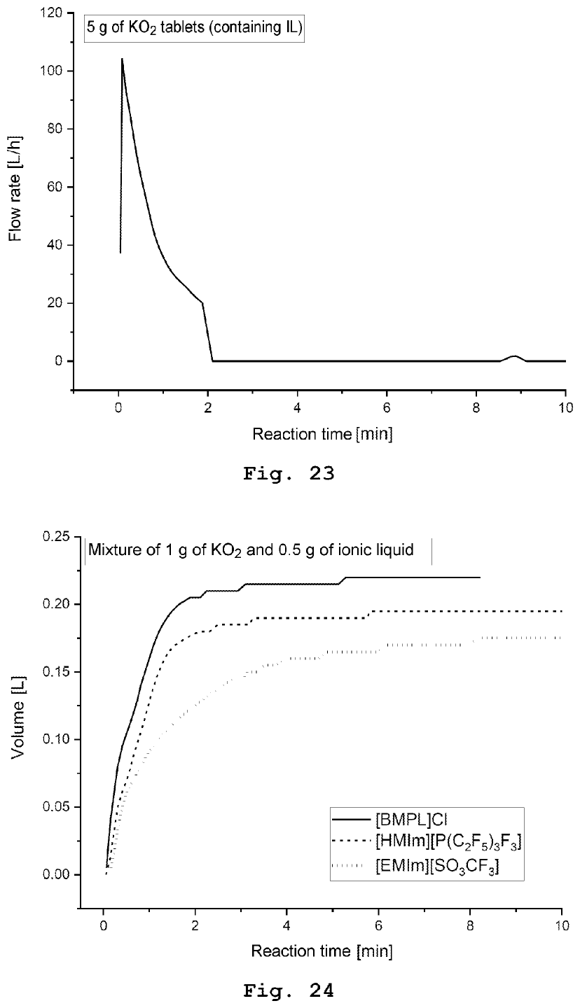

4.55 g of potassium superoxide and 0.45 g of [BMPL][BF(CN)₃] were pressed into tablets. 5 g of these tablets were initially charged in a cylindrical reaction vessel having an internal diameter of 28 mm. Next, at an ambient temperature of room temperature, the reaction for generating oxygen was initiated by adding 10 mL of a 9 M potassium hydroxide solution. The reaction vessel was sealed and the oxygen released by the reaction for generating oxygen was guided out of the reaction vessel through a drum-type gas meter to measure the volume of the oxygen generated. The oxygen flow rate and the length of the reaction time were additionally measured. Recording of the measurement data was halted after 225 minutes. The results are presented in FIGS. 22 and 23 and in Table 9.

TABLE 9

| Flow | Reaction | O₂ | O₂ | Reaction |
|---|---|---|---|---|
| rateₘₐₓ | temperature | volume | volume | duration |
| [L/h] | [° C.] | [L] | [%] | [min] |
| 104 | 27 | 1.11 | 94 | 219 |

It is apparent from this that, in the case of potassium superoxide and [BMPL][BF(CN)₃], pressed into tablets, a yield in gas volume of 1.11 L is reached after 219 minutes of reaction time. The maximum gas volume that can theoretically be generated in this reaction is 1.14 L. It is apparent from the flow curve profile ascertained via the measured flow rates that immediately after addition of the aqueous potassium hydroxide solution a maximum flow rate of 104 L per hour is reached. After the maximum flow rate has been reached, the flow rate decreases continuously.

### Thirteenth Exemplary Embodiment

An open reaction vessel was initially charged with 2 g of pulverulent potassium superoxide and 4 g of a paste consisting of 2 g of potassium superoxide and 2 g of [BMPL][BF(CN)₃]. The reaction vessels were each adjusted to an ambient temperature of +70° C. and held at this ambient temperature for 24 hours. No weighable loss of weight was detected in either sample after 24 h at +70° C. ambient temperature.

### Fourteenth Exemplary Embodiment

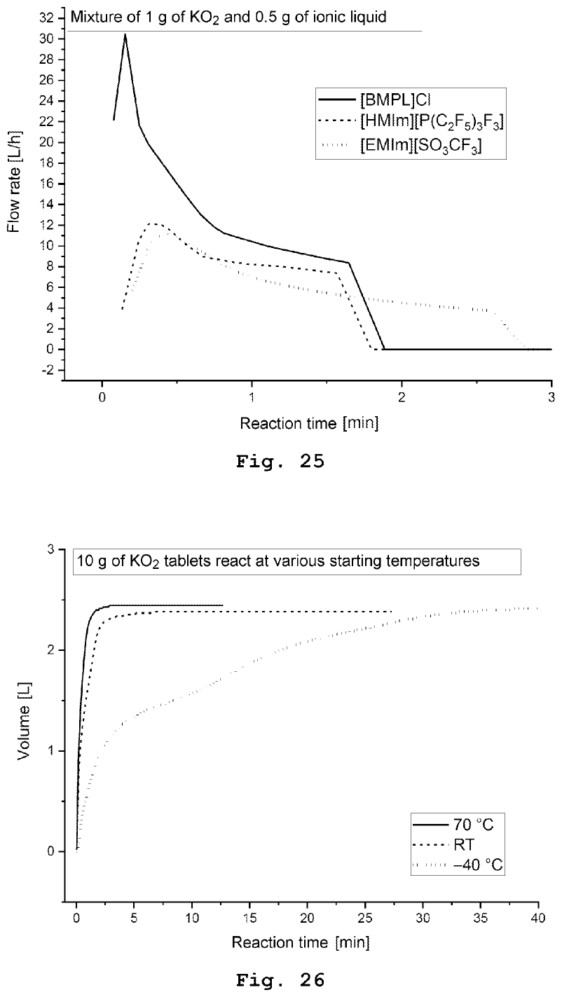

1 g in each case of pulverulent potassium superoxide was initially charged as oxygen source into three cylindrical reaction vessels having an internal diameter of 24 mm. Either 0.5 g of [BMPL]Cl, 0.5 g of [HMIm][P(C₂F₅)₃F₃] or 0.5 g of [EMIm][SO₃CF₃] were added. In contrast to the ionic liquid [BMPL]Cl, the ionic liquids [HMIm][P(C₂F₅)₃F₃] or [EMIm][SO₃CF₃] contain relatively hydrophobic anions. Next, at an ambient temperature of room temperature, the reaction for generating oxygen was initiated by adding 2 mL in each case of a 9 M potassium hydroxide solution. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurement data was halted after 75 minutes since in all reactions the maximum achievable oxygen yield had been reached. The results are presented in FIGS. 24 and 25 and in Table 10.

TABLE 10

| | | After 10 minutes | |
|---|---|---|---|
| | | of reaction time | |
| | Flow | O₂ | O₂ |
| | rateₘₐₓ | volume | volume |
| Ionic liquid | [L/h] | [mL] | [%] |
| [BMPL]Cl | 30 | 220 | 87 |
| [HMIm][P(C₂F₅)₃F₃] | 12 | 195 | 78 |
| [EMIm][SO₃CF₃] | 11 | 175 | 70 |

It is apparent from this that, with the addition of [BMPL]Cl, the maximum yield in gas volume of 220 mL is reached after 5 minutes of reaction time. The addition of [HMIm][P(C₂F₅)₃F₃] results in the maximum yield in gas volume of 200 mL being reached after 26 minutes of reaction time. The addition of [EMIm][SO₃CF₃] results in the maximum yield in gas volume of 190 mL being reached after 41 minutes of reaction time. The maximum gas volume that can theoretically be generated in this reaction is 0.25 L. The flow curve profile ascertained via the measured flow rates has a markedly more plateau-shaped course as a result of addition of the ionic liquids [HMIm][P(C₂F₅)₃F₃] and [EMIm][SO₃CF₃] having hydrophobic anions. As a result of the addition of an ionic liquid having hydrophobic anions, the oxygen is released more continuously and more uniformly.

### Fifteenth Exemplary Embodiment

Pulverulent potassium superoxide and the phyllosilicate mica were intimately mixed in a mass ratio of 10:1 and pressed using a briquetting press into tablets having a mass of 200 mg, a diameter of 6 mm and a fracture resistance of 5 kN.

Next, for one tablet, at an ambient temperature of room temperature, the reaction for generating oxygen was initiated by adding 0.4 mL of a 9 M potassium hydroxide solution. Complete conversion of the potassium superoxide to oxygen, with floating of the tablets, was observed within a reaction time of 2 minutes.

### Sixteenth Exemplary Embodiment

Pulverulent potassium superoxide and the fumed silica Aerosil 200 were intimately mixed in a mass ratio of 10:1 and pressed using a briquetting press into tablets having a mass of 200 mg, a diameter of 6 mm and a fracture resistance of 5 kN.

Next, for one tablet, at an ambient temperature of room temperature, the reaction for generating oxygen was initiated by adding 0.4 mL of a 9 M potassium hydroxide solution. Complete conversion of the potassium superoxide to oxygen, without floating of the tablets, was observed within a reaction time of 2 minutes.

### Seventeenth Exemplary Embodiment

Pulverulent potassium superoxide and the antifoam paraffin were intimately mixed in a mass ratio of 5:1 and pressed using a briquetting press into tablets having a mass of 200 mg, a diameter of 6 mm and a fracture resistance of 5 kN.

Next, for one tablet, at an ambient temperature of room temperature, the reaction for generating oxygen was initiated by adding 0.4 mL of a 9 M potassium hydroxide solution. Complete conversion of the potassium superoxide to oxygen, without floating of the tablets, was observed within a reaction time of 5 minutes.

### Eighteenth Exemplary Embodiment

Pulverulent potassium superoxide and the antifoam silicone oil were intimately mixed in a mass ratio of 2:1 and pressed using a briquetting press into tablets having a mass of 200 mg, a diameter of 6 mm and a fracture resistance of 5 kN.

Next, for one tablet, at an ambient temperature of room temperature, the reaction for generating oxygen was initiated by adding 0.4 mL of a 9 M potassium hydroxide solution. Complete conversion of the potassium superoxide to oxygen, without floating of the tablets, was observed within a reaction time of 30 minutes.

### Nineteenth Exemplary Embodiment

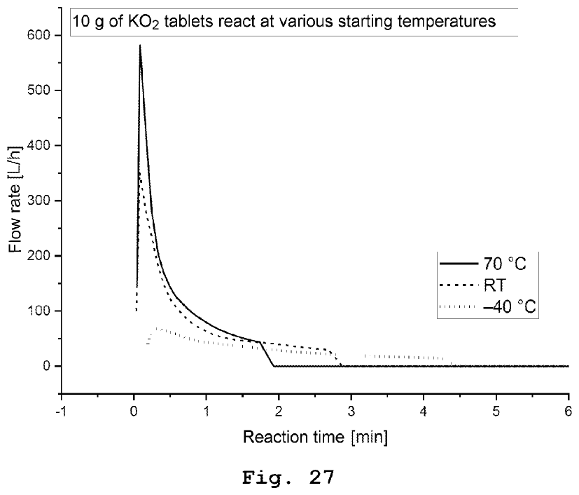

10 g in each case of potassium superoxide were pressed in the form of tablets having a fracture resistance of 60 N and initially charged into three cylindrical reaction vessels having an internal diameter of 28 mm. At an ambient temperature of +70° C., room temperature or −40° C., the reaction for generating oxygen was initiated by adding 20 mL in each case of an aqueous 9 M potassium hydroxide solution that had been adjusted to the respective ambient temperature. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurement data was halted after 70 minutes since the maximum achievable oxygen volume had been reached at every ambient temperature. The results are presented in FIGS. 26 and 27 and in Table 11.

TABLE 11

| Starting | Flow | Reaction | O₂ | O₂ | Reaction |
|---|---|---|---|---|---|
| temperature | rateₘₐₓ | temperature | volume | volume | duration |
| [° C.] | [L/h] | [° C.] | [L] | [%] | [min] |
| −40 | 68 | 14 | 2.4 | 97 | 62 |
| RT | 351 | 48 | 2.4 | 97 | 7 |
| +70 | 582 | 80 | 2.4 | 97 | 3 |

It is apparent from this that, at an ambient temperature of +70° C., the maximum yield in gas volume of 2.4 L is reached after 3 minutes of reaction time. At an ambient temperature of room temperature, the maximum yield in gas volume of 2.4 L is reached after 7 minutes of reaction time. At an ambient temperature of −40° C., the maximum yield in gas volume of 2.4 L is reached after 62 minutes of reaction time. The flow curve profile ascertained via the measured flow rates has a markedly more plateau-shaped course at an ambient temperature of −40° C. As a result of an ambient temperature of −40° C., the oxygen is released more continuously and uniformly.

### Twentieth Exemplary Embodiment

10 g in each case of potassium superoxide were pressed in the form of tablets having a fracture resistance of 60 N and initially charged into three cylindrical reaction vessels having an internal diameter of 28 mm. At an ambient temperature of +70° C., room temperature or −20° C., the reaction for generating oxygen was initiated by adding 20 mL in each case of a 50% aqueous ethylene glycol mixture that had been adjusted to the respective ambient temperature. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurement data was halted after 70 minutes since the maximum achievable oxygen volume had been reached at every ambient temperature. The volume of the oxygen generated and the flow curve profile ascertained via the measured flow rates are similar to the results shown in exemplary embodiment 19. Here too, at an ambient temperature of −20° C. the oxygen is released more continuously and uniformly.

### Twenty-First Exemplary Embodiment

10 g in each case of potassium superoxide were pressed in the form of tablets having a fracture resistance of 60 N and initially charged into three cylindrical reaction vessels having an internal diameter of 28 mm. At an ambient temperature of +70° C., room temperature or −20° C., the reaction for generating oxygen was initiated by adding 20 mL in each case of a 40% aqueous propylene glycol mixture that had been adjusted to the respective ambient temperature. The reaction vessels were each sealed and the oxygen released by the reaction for generating oxygen was guided out of the reaction vessels through a drum-type gas meter to measure the volume of the oxygen generated. The oxygen flow rates and the length of the reaction time were additionally measured. Recording of the measurement data was halted after 70 minutes since the maximum achievable oxygen volume had been reached at every ambient temperature. The volume of the oxygen generated and the flow curve profile ascertained via the measured flow rates are similar to the results shown in exemplary embodiment 19. Here too, at an ambient temperature of −20° C. the oxygen is released more continuously and uniformly.

1. A composition for generating oxygen, comprising:
an oxygen source, said oxygen source being potassium superoxide;
a water-containing solution or a water-containing mixture, said water-containing solution containing a given amount of a salt or a given amount of a salt together with a given amount of an antifreeze, or said water-containing mixture containing a given amount of an antifreeze, to effectively lower a freezing point of said water-containing solution or of said water-containing by at least 10° C. compared to a freezing point of the water;
said salt of said water-containing solution being an alkali metal hydroxide, an alkali metal hydroxide hydrate, an alkali metal chloride, an alkali metal chloride hydrate, a hydroxide with an organic cation, a hydrate of a hydroxide with an organic cation, or a mixture of at least two compounds selected from the group consisting of an alkali metal hydroxide, an alkali metal hydroxide hydrate, an alkali metal chloride, an alkali metal chloride hydrate, a hydroxide with an organic cation, and a hydrate of a hydroxide with an organic cation;
said antifreeze including an alcohol or consisting of an alcohol.

2. The composition according to claim 1, consisting of said oxygen source and said water-containing mixture or said water-containing solution.

3. The composition according to claim 1, wherein said antifreeze comprises or consists of a monohydric alcohol a dihydric alcohol, a trihydric alcohol, or a mixture of at least two alcohols selected from the group consisting of a monohydric alcohol, a dihydric alcohol, and a trihydric alcohol.

4. The composition according to claim 1, wherein said monohydric alcohol is ethanol or octanol, said dihydric alcohol is propylene glycol or ethylene glycol, and said trihydric alcohol is glycerol.

5. The composition according to claim 1, wherein said alkali metal hydroxide is potassium hydroxide or sodium hydroxide, said alkali metal hydroxide hydrate is a hydrate of potassium hydroxide or a hydrate of sodium hydroxide, said alkali metal chloride is sodium chloride, said alkali metal chloride hydrate is a hydrate of lithium chloride, said hydroxide with an organic cation is a tetraalkylammonium hydroxide, and said hydrate of a hydroxide with an organic cation is a hydrate of a tetraalkylammonium hydroxide.

6. The composition according to claim 5, wherein said tetraalkylammonium hydroxide is a tetrabutylammonium hydroxide and said hydrate of a tetraalkylammonium hydroxide is a hydrate of tetrabutylammonium hydroxide.

7. The composition according to claim 1, wherein a total weight of said salt or a total weight of said salt together with a total weight of said antifreeze in the water-containing solution relative to a total weight of said water-containing solution or wherein the total weight of said antifreeze in said water-containing mixture relative to a total weight of said water-containing mixture is at least 25% by weight.

8. The composition according to claim 7, wherein the total weight of said water-containing mixture is at least 40% by weight.

9. The composition according to claim 1, wherein said oxygen source is present in solid form, or wherein said oxygen source is present in suspended form in an ionic liquid, or wherein said oxygen source and an ionic liquid are present in a pressed form with said ionic liquid forming a binder, and wherein said ionic liquid is a salt that is in a liquid state and consists of at least one cation and at most 100 cations and of at least one anion and at most 100 anions.

10. The composition according to claim 1, further comprising, as a further constituent, at least one additive independently selected from sodium dihydrogenphosphate or potassium hydroxide, an additional substance and an antifoam.

11. The composition according to claim 10, wherein said additional substance is a phyllosilicate or fumed silica.

12. The composition according to claim 10, wherein said antifoam comprises or consists of octanol, paraffin wax or a polysiloxane.

13. The composition according to claim 1, wherein a total weight of said oxygen source relative to a total weight of the composition amounts to at least 5% by weight and at most 90% by weight, and wherein a remainder of the composition consists of the water-containing solution or the water-containing mixture and, optionally, the ionic liquid and/or a further constituent.

14. An oxygen generator, comprising:
a first and a second compartment, an opening for releasing or a conduit for discharging oxygen formed in the oxygen generator, and the composition according to claim 1;
said oxygen source being disposed in said first compartment and the water-containing solution or the water-containing mixture being disposed in said second compartment;
a physical barrier configured to separate said first compartment from said second compartment and a device for selectively overcoming said physical barrier, wherein said physical barrier is arranged to enable said oxygen source and said water-containing solution or said water-containing mixture, after overcoming said physical barrier, to come into contact with one another; and
said opening or conduit being arranged to allow the oxygen being formed to exit through said opening or through said conduit.

15. The oxygen generator according to claim 14, further comprising an additive selected from the group consisting of sodium dihydrogenphosphate or potassium hydroxide, an additional substance and an antifoam disposed either in said first compartment or in said second compartment,

16. The oxygen generator according to claim 14, further comprising a delaying device disposed and configured to allow a total amount of said water-containing solution present in the oxygen generator or a total amount of said water-containing mixture present in the oxygen generator, after overcoming said physical barrier, comes into contact only gradually with a total amount of said oxygen source present in the oxygen generator.

17. The oxygen generator according to claim 16, wherein said delaying means is a perforated, semipermeable membrane or a bulk material, which surrounds or covers said oxygen source or is mixed with said oxygen source and is inert with respect to said oxygen source and said water-containing solution or said water-containing mixture.

18. A method of generating oxygen, the method which comprises providing the composition according to claim 1 and bringing the oxygen source and the water-containing solution or the water-containing mixture of the composition, and optionally an ionic liquid, an additive, an additional substance, or an antifoam, into contact with one another, so as to generate oxygen.

19. The method according to claim 18, which comprises bringing the components into contact with one another at a temperature in a temperature range from −70° C. to +110° C.

20. The method according to claim 19, which comprises bringing the components into contact with one another at a temperature in a temperature range from −40° C. to −20° C.
